(19) United States
(12) Patent Application Publication
(10) Pub. No.: US 2005/0103986 A1
(43) Pub. Date: May 19, 2005

(54) Wide field of view quadrant sensor

(76) Inventor: Richard Leon Hartman, Huntsville, AL (US)

Correspondence Address: Richard L. Hartman;Advanced Optical Systems, 6767 Old Madison Pike, Huntsville, AL, 35801, US

(21) Appl. No.: 10/992,343

(22) Filed: Nov. 18, 2004

Related U.S. Application Data
(60) Provisional application No. 60/523,008, filed on Nov. 18, 2003.

(51) Int. Cl. H01J 40/14

(52) U.S. Cl. 250/216

(57) ABSTRACT

A system for detecting the angle of arrival of a beam of light from illuminated targets. A reflective shadow caster illuminates the front surface of a tapered fiber bundle in a manner that encodes the angle of arrival into quadrant intensities. The fiber optic taper collects the energy from the large collection aperture, and illuminates a quadrant detector, increasing the amount of light collected, and thus the signal.

### CROSS REFERENCE TO RELATED APPLICATIONS

This application claims the benefit of PPA 60/523,008, filed Nov. 18, 2003 by the present inventor.

### FEDERALLY SPONSORED RESEARCH

Not Applicable

### FIELD OF INVENTION

This invention relates to a quadrant sensor with a wide field of view, as used, for example, in a semi-active laser seeker.

### DISCUSSION OF PRIOR ART

The semi-active laser seeker is the heart of many smart weapon systems. In such systems a laser is used to illuminate a target, and a seeker uses optics and detectors to determine where the target is relative to the seeker. Such seekers are used, for example, in the PAVEWAY bombs, the HELLFIRE missile, and the COPPERHEAD munition. These applications are discussed at www.fas.org/man/dod-101/sys/smart/lgb.htm. In the prior art, an optical system with a limited field of view, for example, 4°, is mounted on a gimbal. When a laser such as that described in U.S. Pat. No. 4,091,412, illuminates the target, some reflected energy is captured by the entrance lens of the sensor/seeker, and brought to near-focus on a quadrant detector. At near focus, the spot of laser light is a blur circle, and usually falls on two to four elements. The ratio of the signal on those elements measures how far off boresight the seeker is pointed, and is used to drive the gimbal to bring the spot on axis.

The prior solution is limited because it requires the use of a gimbal, which is heavy, expensive, and requires position sensors, drive systems, and electronics.

There is interest in strap-down seekers that do not use gimbals. A strap-down sensor must have a wider field of view to accommodate possible target locations, perhaps as much as ±30°. While there are attempts to make such systems, conventional optical systems are badly distorted over such a wide field of view. Typically the relation between the target line of sight and the signal is not linear, and becomes weak at the edges of the field of view. U.S. Pat. No. 4,070,573 describes an approach that composes an annular first lens, a primary optical barrel, a secondary optical barrel, a secondary mirror, and a second lens, and that therefore is complex and expensive.

### OBJECTS AND ADVANTAGES

Accordingly, several objects and advantages of my invention are:
a. To provide a wide field of view quadrant sensor/seeker.
b. To provide a well behaved transfer curve of signal versus angle.
c. To provide significant transfer curve near the edges of the field of view.
d. To provide a sensor made primarily from commercial off-the-shelf components.

### SUMMARY ##

### DRAWINGS

FIG. 1 shows an “exploded view” of the invention.

FIGS. 2A and 2B shows a cross section of the operation

FIG. 3 shows the design with a large number of short shadow casters in an egg crate configuration.

### DESCRIPTION

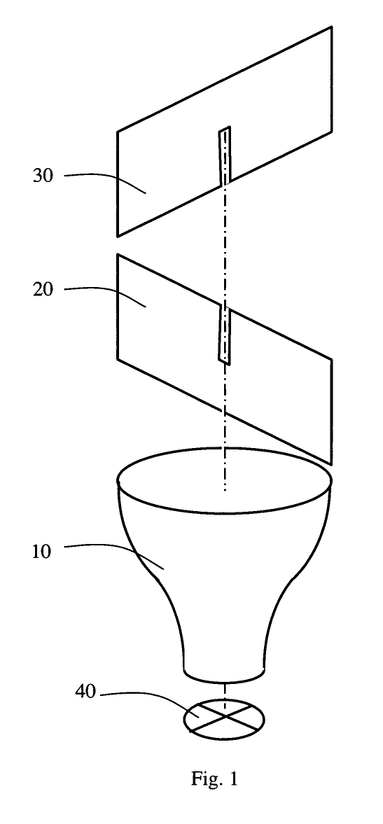

FIG. 1. The Preferred Embodiment.

The key component of this invention is a fiber optic taper 10. This taper consists of a number of fiber optic elements bonded together. The bundle is softened by heating, and drawn to a narrower diameter at one end. The taper is normally used to enlarge or shrink an image. An image source placed at one end is magnified or shrunk when viewed at the other end, because each small element of the image is carried through a tapered fiber. Commercial off-the-shelf tapers are available with diameter ratios from 2/1 to 5/1.

Shadow caster 20 is a thin opaque sheet reflective on both sides. It is attached to shadow caster 30 arranged at right angles to shadow caster 20. These units are assembled and attached to taper 10. This assembly is attached to, or placed in close proximity to, quadrant detector 40, which may be a commercial off-the-shelf item. Quadrant detector 40 consists of four separate photo-sensitive areas.

Operation

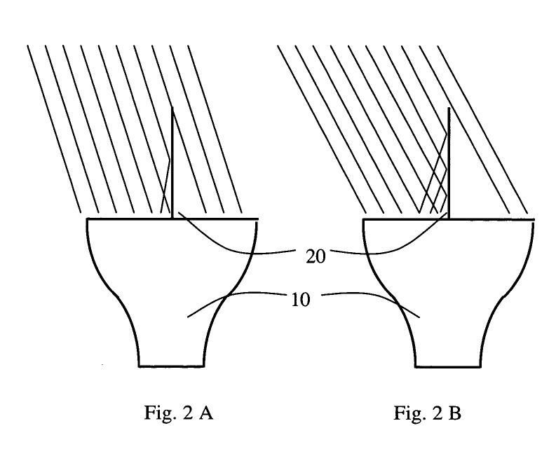

FIGS. 2A and 2B

Rays of light from a distant reflection impinge on the assembly. If the rays arrive parallel to the axis of the system, the four areas of the input face are uniformly illuminated, and the four areas of the output are therefore uniformly illuminated. The difference of the signals on the two sides is zero. As the source is moved to the side, as in FIG. 2A, shadow caster 20 blocks some of the rays, reducing the signal on the “off side.” Since shadow caster 20 is reflective, the blocked raysa are reflected onto the “on” side, increasing the signal. The difference of the signal on two quadrants now is non zero. As the angle increases as shown in FIG. 2B, the shadowed area increases, the amount of light reflected onto the “on” side, and the size of the difference signal increases.

In using a quadrant detector to measure angle, the difference signal is usually divided by the sum of the signals, to eliminate variables of energy source, range, and atmospheric attenuation. In this case, a mathematical analysis, confirmed by experiments, shows that the relation between angle and result is a linear function that persists to the edge of the field of view. In comparison, prior art systems have reduced performance near the edges of the field of view.

By having the shadow caster in the form of a cross consisting of shadow casters 20 and 30, the system works in two dimensions.

The maximum angle at which the proportional signal disappears is when the off side is completely shadowed, or when tan (theta)=radius/height.

### Additional Embodiments

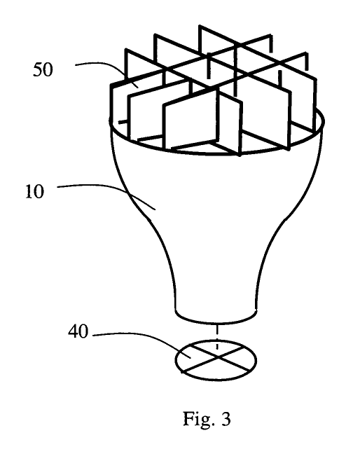

FIG. 3 Egg Crate Shadow Caster

For a field of view of 30°, the height of shadow caster 20 is about twice the radius of fiber taper 10. It is possible to reduce the height with building an eggcrate shadow caster 50. The more elements, the smaller the height for the same field of view. The outward facing sides must be reflective, and the inward sides absorptive.

The shadow caster components may be shaped other than rectangular, in order to tailor the relationship between angle and resulting signal.

Fiber taper 10 has a limit to acceptance angle associated with numerical aperture of the individual fibers. In addition, the total energy on the system falls by the cosine of the angle, which becomes noticeable at large angles. One way to reduce this effect is to cut and polish the taper in an area where the fibers point away from the center.

Fiber taper 10 could also consist of four separate tapers. An alternate in this embodiment is to use individual detectors rather than a quadrant detector, in order to use more sensitive detectors. It is also possible to have a hole up in the center for use by an optical or mechanical fuze.

### CONCLUSIONS, RAMIFICATIONS AND SCOPE OF THE INVENTION

Thus the reader will see that the wide field of view quadrant sensor of this invention provides a simple, reliable, economical, rugged device that provides superior performance in providing a linear measurement of the angle of incidence of light, all the way to the edges of the designed field of view.

While my above description contains many specificities, these should not be construed as limitations on the scope of the invention, but rather as an exemplification of one preferred embodiment thereof. Many other variations are possible.

1. A sensor system for detecting the angle of arrival of light comprising:
a. Elements that cast shadows and reflections
b. A means of collecting light
c. A means of detecting light in a plurality of locations

2. A sensor system consisting of:
a. Flat two sided mirrors in a cross configuration
b. A fiber optic bundle taper
c. A quadrant detector

3. The shadow casting elements of claim 1 wherein the elements are of a variety of shapes to provide a variety of signal responses as a function of angle

4. The means of collecting light of claim 1 wherein the light collector consists of a plurality of fiber optic tapers

5. The means of detecting light in claim 1 wherein a plurality of detectors is used instead on one multi-element detector.
